(19) United States
(12) Patent Application Publication
(10) Pub. No.: US 2021/0184863 A1
(43) Pub. Date: Jun. 17, 2021

(54) METHOD AND SYSTEM FOR REGULATION OF BLOCKCHAIN-BASED PAYMENTS

(71) Applicant: MASTERCARD ASIA/PACIFIC PTE. LTD., Singapore (SG)

(72) Inventors: Kamran SHAHIN, Dubai (AE); Pankaj ASTHAANA, Dubai (AE)

(73) Assignee: MASTERCARD ASIA/PACIFIC PTE. LTD., Singapore (SG)

(21) Appl. No.: 16/710,524

(22) Filed: Dec. 11, 2019

(51) Int. Cl. H04L 9/32; H04L 9/06; G06Q 20/38; G06Q 20/02

(52) U.S. Cl. CPC H04L 9/3263; H04L 9/3247; H04L 9/0637; G06Q 20/38215; G06Q 2220/00; G06Q 20/3825; G06Q 20/3829; H04L 2209/56; H04L 2209/38; G06Q 20/02

(57) ABSTRACT

A method for ensuring regulatory oversight of transaction activity and storage thereof on a blockchain includes: establishing a secure communication channel between a first computing system associated with a first entity and a second computing system associated with a second entity; receiving transaction data from the first computing system, wherein the transaction data includes a first digital certificate from the first computing system and second digital certificate from the second computing system; identifying a regulatory node that has regulatory oversight of the first entity or the second entity; transmitting at least a portion of the transaction data to the regulatory node; receiving a third digital certificate from the regulatory node; and posting a transaction hash including the first digital certificate, second digital certificate, and third digital certificate to a blockchain.

### FIELD

The present disclosure relates to ensuring regulatory oversight of transaction activity and storage thereof on a blockchain while maintaining the immutability and anonymity of transactional data when an opaque blockchain is used.

### BACKGROUND

Blockchain gained popularity as a tool to facilitate the use of cryptographic currency for payment transactions. One of the benefits of using a blockchain is that it serves as an immutable record, facilitating the ability to audit and verify past transactions that are cryptographically guaranteed and in a manner that prevents the conducting of fraud or changing of the records. In addition, blockchain can provide for anonymity of entities involved in a transaction, as transactions occur between wallets defined by cryptographic key pairs, without identity being necessary.

However, there are many instances where anonymity of entities involved in transactions prevents some entities from utilizing blockchain. For instance, many industries may require regulatory oversight of transactions, where a regulatory entity must be able to view transaction activity and, in some cases, approve a transaction before it is processed. In such instances, entities subject to such oversight are unable to use a blockchain for their transactions without manually providing transaction activity to the regulatory entity, which can be a laborious process and negate the advantages of using a blockchain. That is, the current technology requires such an entity to track such transactions through a separate system, which can be a manual or other form of log, to comply with regulatory or other oversight. This can be computationally complex in that it requires some form of API (application program interface) or similar mechanism to be associated with the transaction flow often with human intervention, or worst purely manual input into some form of oversight report. Also, such reporting can introduce compromises in both immutability and anonymity depending on how they are deployed.

Thus, there is a need for a system where regulatory oversight of blockchain-based payments can be achieved without compromising the immutability and anonymity of a blockchain to enable entities to take advantage of blockchain benefits while maintaining regulation. The present disclosure reveals one way of potentially many in solving this technological challenge.

### SUMMARY

The present disclosure provides a description of systems and methods for ensuring regulatory oversight of transaction activity and storage thereof on a blockchain. A permissioned blockchain is used, where a moderating node facilitates transactions involving two entities. When a first entity wants to transact with a second entity, the moderating node opens a secure communication channel between the two, enabling the two entities to exchange messages and agree on terms for the transaction. When they are ready, one of the entities submits transaction information to the moderating node along with electronic certificates from both entities, which can be used to verify the entities and their participation in the blockchain. If either entity is subject to regulation, the transaction is forwarded to a regulatory entity, which must provide its own certificate as approval of the transaction, before the transaction is processed and posted to the blockchain. This results in the regulatory node automatically receiving transaction data as necessary, alleviating the need for the entities to self-report transactions, but still take advantageous of use of a blockchain.

A method for ensuring regulatory oversight of transaction activity and storage thereof on a blockchain includes: establishing, by a processing server, a secure communication channel between a first computing system associated with a first entity and a second computing system associated with a second entity; receiving, by a receiver of the processing server, transaction data from the first computing system, wherein the transaction data includes a first digital certificate from the first computing system and second digital certificate from the second computing system; identifying, by the processing server, a regulatory node that has regulatory oversight of the first entity or the second entity; transmitting, by a transmitter of the processing server, at least a portion of the transaction data to the regulatory node; receiving, by the receiver of the processing server, a third digital certificate from the regulatory node; and posting, by the processing server, a transaction hash including the first digital certificate, second digital certificate, and third digital certificate to a blockchain.

A system for ensuring regulatory oversight of transaction activity and storage thereof on a blockchain includes: a first computing system associated with a first entity; a second computing system associated with a second entity; a regulatory node; and a processing server, wherein the processing server establishes a secure communication channel between the first computing system and the second computing system, receives, by a receiver of the processing server, transaction data from the first computing system, wherein the transaction data includes a first digital certificate from the first computing system and second digital certificate from the second computing system, identifies the regulatory node having regulatory oversight of the first entity or the second entity, transmits, by a transmitter of the processing server, at least a portion of the transaction data to the regulatory node, receives, by the receiver of the processing server, a third digital certificate from the regulatory node, and posts a transaction hash including the first digital certificate, second digital certificate, and third digital certificate to a blockchain.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for regulatory oversight of blockchain transaction activity in accordance with exemplary embodiments.

FIG. 2 is a block diagram illustrating the processing server of the system of FIG. 1 for facilitating regulatory oversight of blockchain transactions in accordance with exemplary embodiments.

FIG. 3 is a flow diagram illustrating a process for ensuring regulatory oversight of blockchain transactions as executed by the processing server of FIG. 2 in accordance with exemplary embodiments.

FIG. 4 is a flow chart illustrating an exemplary method for ensuring regulatory oversight of transaction activity and storage thereof on a blockchain in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### System for Regulatory Oversight of Blockchain Transactions

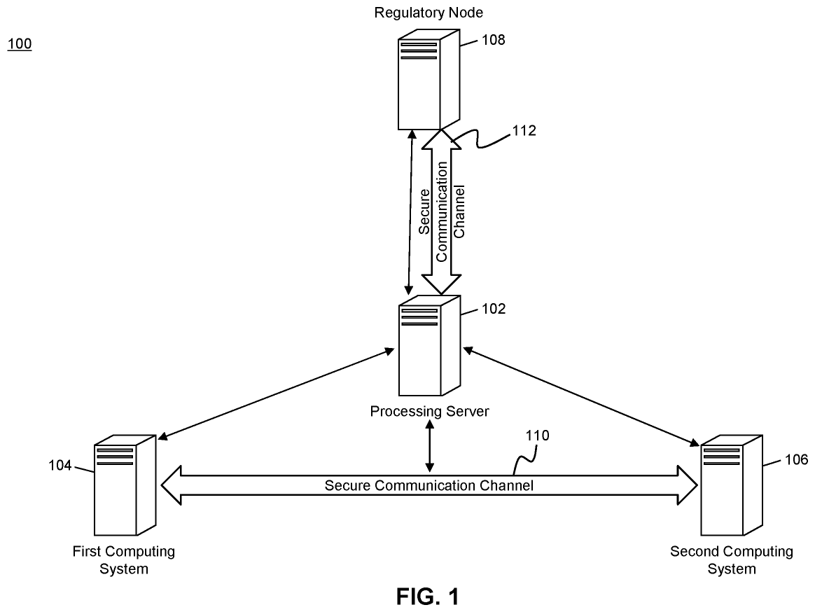

FIG. 1 illustrates a system 100 for ensuring regulatory oversight of blockchain transaction activity via the use of a permissioned blockchain and facilitated communication channels.

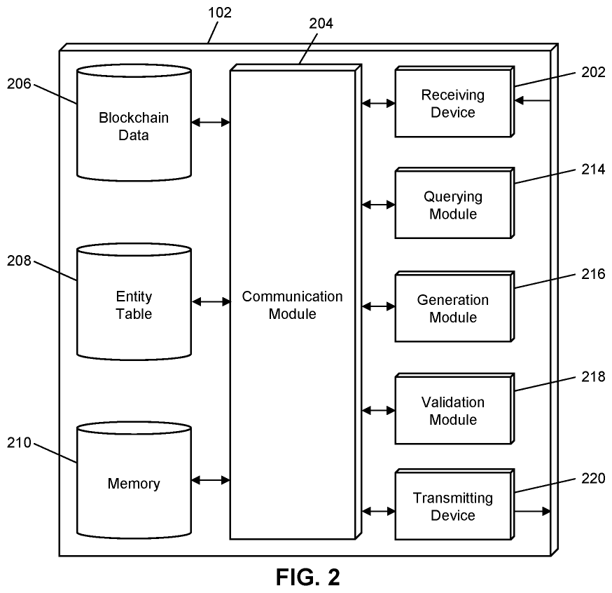

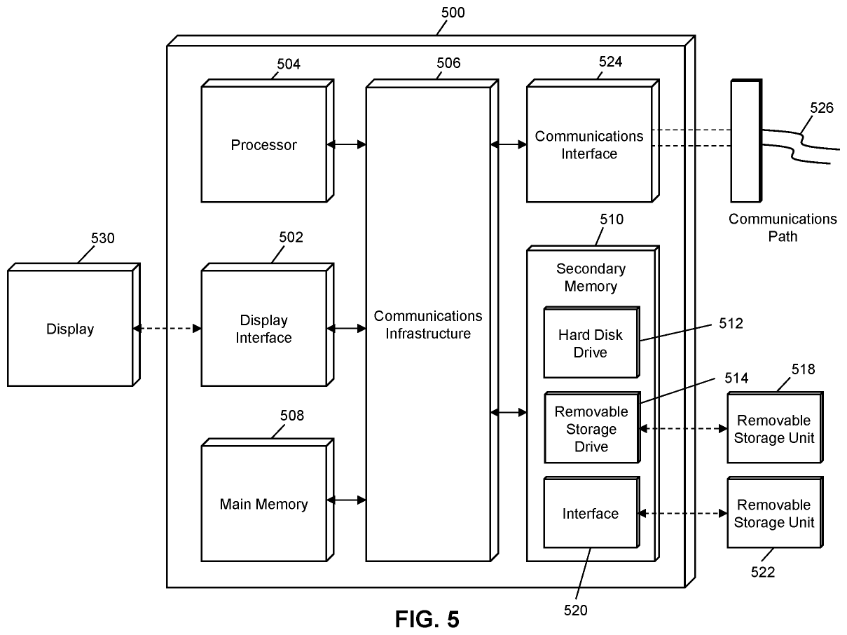

The system 100 may include a processing server 102. The processing server 102, discussed in more detail below, may be a node in a blockchain network or other specially configured computing system in communication therewith that is configured to facilitate regulatory oversight of transaction activity in a blockchain network. The blockchain network may be comprised of a plurality of blockchain nodes, which may include traditional consensus nodes, one or more moderating nodes, and one or more regulatory nodes. In some cases, the processing server 102 may be a moderating node. Each node in the blockchain network, as well as the processing server, may be a specially configured computing system, such as illustrated in FIG. 2 and FIG. 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain may be a distributed ledger that is comprised of at least a plurality of blocks. Each block may include at least a block header and one or more data values. Each block header may include at least a timestamp, a block reference value, and a data reference value. The timestamp may be a time at which the block header was generated, and may be represented using any suitable method (e.g., UNIX timestamp, DateTime, etc.). The block reference value may be a value that references an earlier block (e.g., based on timestamp) in the blockchain. In some embodiments, a block reference value in a block header may be a reference to the block header of the most recently added block prior to the respective block. In an exemplary embodiment, the block reference value may be a hash value generated via the hashing of the block header of the most recently added block. The data reference value may similarly be a reference to the one or more data values stored in the block that includes the block header. In an exemplary embodiment, the data reference value may be a hash value generated via the hashing of the one or more data values. For instance, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single node in the blockchain network prior to the generation and addition of a new block to the blockchain in order for the change to be made permanent. Computational and communication limitations may make such a modification exceedingly difficult, if not impossible, thus rendering the blockchain immutable.

In an exemplary embodiment, the blockchain may be an opaque, permissioned blockchain. An opaque blockchain may be a blockchain where the blockchain data values included therein include data that is unclear to any unauthorized entity. For instance, the blockchain data values may include hash values that are representative of a payment involving two entities, where the hash value may be generated via the application of a one-way hashing algorithm to transaction data for the payment. In such instances, only entities aware of the underlying transaction data would be able to generate the hash value and thereby validate the transaction and hash, whereas any other parties viewing the hash on the blockchain would be unable to discern the nature of the data value. Additional information regarding the use of opaque blockchains can be found in U.S. patent application Ser. No. 14/950,117, entitled “Method and System for Gross Settlement by Use of an Opaque Blockchain,” filed Nov. 24, 2015, which is herein incorporated by reference in its entirety.

A permissioned blockchain may be any blockchain where participation therein is only allowed by authorized parties. In such cases, moderating nodes may be required to moderate involvement of entities in the blockchain, such as through only accepting new transaction submissions from authorized entities, requiring explicit approval of all proposed transactions, etc. In these cases, moderating nodes may enforce such permissions through the use of digital certificates, distributed keys, or other such mechanisms. Additional information regarding the use of permissioned blockchains and consensus thereof can be found in U.S. patent application Ser. No. 15/163,007, entitled “Method and System for an Efficient Consensus Mechanism for Permissioned Blockchains Using Bloom Filters and Audit Guarantees,” filed May 24, 2016, which is herein incorporated by reference in its entirety.

In the system 100, a first computing system 104 may be an authorized participant in the permissioned blockchain and may have a desire to conduct a payment transaction with a second computing system 106, where a blockchain data value may be used to store a hash of the conducted payment transaction. The first computing system 104 and second computing system 106 may be any type of computing system specially configured to participate in the system 100 as discussed herein, such as the computing system 500 of FIG. 5, discussed in more detail below. In the system 100, the first computing system 104 and second computing system 106 may each be registered with the processing server 102 as part of the permission to participate in the blockchain. Registration may include the providing of a public key of a cryptographic key pair of each of the computing systems to the processing server 102 and/or distribution of an electronic certificate to the computing systems for use in future authentication of the computing system as an authorized participant.

When the first computing system 104 is interested in conducting a transaction with the second computing system 106, the first computing system 104 may submit a request to the processing server 102 using a suitable communication network and method. The request may include a reference identifier suitable for identification of the second computing system 106, such as a public key of the second computing system's cryptographic key pair, an identification number, a network address, etc. The processing server 102 may receive the request with the identifier and identify the second computing system 106. The processing server 102 may then establish a secure communication channel 110 between the first computing system 104 and the second computing system 106. In some embodiments, the first computing system 104 may be unable to directly identify or communicate with the second computing system 106 in the system 100 without use of the secure communication channel 110. The secure communication channel 110 may utilize any communication networks and protocols suitable for securing the communications between the two entities, such as the use of transport layer security (TLS) or shared secrets via a key exchange between the first computing system 104 and second computing system 106.

The first computing system 104 and the second computing system 106 may then exchange messages and data using the secure communication channel. For instance, the first computing system 104 and second computing system 106 may exchange information regarding contracts, supplies, purchase orders, invoices, etc. and eventually come to a decision regarding a subsequent transaction involving the two systems, such as payment from the first computing system 104 to the second computing system 106 or vice versa, where the payment may be a cryptographic currency payment, a fiat currency payment, a wire transfers, etc., or where the transaction may be any other suitable type of transaction, such as a contract between the entities associated with each computing system. In some embodiments, the processing server 102 may be prohibited from accessing any of the messages or data exchanged using the secure communication channel 110.

Once the first computing system 104 and the second computing system 106 agree on their transaction, one of the systems may submit the data for the transaction to the processing server 102. In some embodiments, the transaction data may be hashed and only the hash value may be submitted to the processing server 102. In other embodiments, the processing server 102 may receive the transaction data and may generate the hash via applying a one-way hashing algorithm to the received transaction data. In addition to the transaction data, the computing systems may provide a digital certificate from each of the computing systems. In some cases, the digital certificate may be an electronic certificate registered to the computing system, such as may have been provided by the processing server 102 or a moderating node of the blockchain network. In other cases, the digital certificate may be a digital signature generated via signing of the transaction data and/or transaction hash using the private key of a computing system's registered cryptographic key pair.

The processing server 102 may receive the transaction data and the digital certificates from one of the computing systems. The processing server 102 may validate each of the digital certificates to ensure that the participating entities are authorized for participation in the permissioned blockchain. Validation of the digital certificates may be based on the type of certificate used. For instance, if electronic certificates are used, the processing server 102 may validate that each electronic certificate was registered to the first computing system 104 and second computing system 106. In cases where digital signatures are used, the processing server 102 may validate the digital signature using the respective computing system's public key. In some instances, the submission may include identifiers for each of the computing systems, which may be used by the processing server 102 to identify the electronic certificates or public keys used in the validation. If validation is unsuccessful, no processing of the transaction may be performed.

If validation of the transaction and identifies of the first computing system 104 and second computing system 106 is successful, then, in traditional systems, the transaction hash may be added to the blockchain via inclusion in a new block and consensus thereof by other nodes in the blockchain. In some cases, a moderating node (e.g., the processing server 102 or other system configured to perform as a moderating node) may first provide its own digital certificate for the transaction, as discussed below.

In the system 100, a regulatory entity may have regulatory oversight of the entity associated with the first computing system 104 and/or the second computing system 106, such as regulatory agency, government agency, etc. The regulatory entity may have a regulatory node 108, which may be a node in the blockchain network. When the transaction is validated and ready for submission, the processing server 102 may electronically transmit the transaction data to the regulatory node 108 for approval thereby. The regulatory node 108 may review the transaction data and other information regarding the first computing system 104 and second computing system 106. The regulatory node 108 may approve or deny the transaction based on their review of the transaction. For instance, if the regulatory agency provides oversight for financial regulation, the regulatory node 108 may review the transaction data to determine spending by the respective computing system. For example, the first computing system 104 may agree to buy a specified number of widgets from the second computing system 106 (e.g., via their respective entities). In such an example, the regulatory agency may review transactions to monitor for purchase or sales to ensure that the specified number of widgets is allowed to be purchased by the first computing system 104 and from the second computing system 106.

If the regulatory node 108 does not approve the transaction, the transaction may not be completed. In such an instance, the processing server 102 may inform the first computing system 104 and/or second computing system 106 to inform them any reasoning or other information regarding the denial. If the regulatory node 108 approves the transaction, then the regulatory node may provide their own digital certificate with their response to the processing server 102. The processing server 102 may validate the regulatory node's digital certificate, such as using the methods discussed above. If the validation is unsuccessful, then the transaction may be stopped. If the validation is successful, the transaction may be included in a new block that is confirmed by other nodes in the blockchain network and added to the blockchain. In cases where multiple regulatory agencies may be involved, the process may include the approval and validation thereof for each of the regulatory agencies before the transaction proceeds to confirmation.

In some embodiments, the regulatory node 108 may be required to review communications between the first computing system 104 and the second computing system 106 as part of the regulatory oversight. In such embodiments, after the secure communication channel 110 is opened the processing server 102 may open a secure communication channel 112 between the processing server 102 and the regulatory node 108, where the secure communication channel 112 may use the same communication network and protocols as the secure communication channel 110. The processing server 102 may then provide the regulatory node 108 with communication data regarding communications using the secure communication channel 110. In some instances, the first computing system 104 or second computing system 106 may provide the processing server 102 with such communications. In other instances, communications may be automatically copied to the secure communication channel 112. In an exemplary embodiment, the processing server 102 may be unable to or otherwise prevented from accessing content of the communications provided to the regulatory node 108, such as to avoid non-compliance with regulations. In some instances, other communications between the processing server 102 and the regulatory node 108, such as for the oversight and/or approval of a transaction, may also use the secure communication channel 112.

The methods and systems discussed herein enable two computing systems to engage in transactional activity, where storage of information regarding that activity can be stored safely and securely in a blockchain, while still maintaining compliance with applicable regulations. The use of a regulatory node 108 and the secure communication channels 110 and 112 enable automatic forwarding of necessary data to the regulatory node 108, enabling the first and second entities to focus on their business and not have to deal with self-reporting and complicated rules and instructions, increasing the efficiency and speed at which the entities can do business.

### Processing Server

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from first computing systems 104, second computing systems 106, regulatory nodes 108, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by first computing systems 104 and second computing systems 106 that may be superimposed or otherwise encoded with requests for communication channels, transaction data for forwarding to regulatory nodes 108, transaction data for validation accompanied by digital certificates, registration requests including public keys, etc. The receiving device 202 may also be configured to receive data signals electronically transmitted by regulatory nodes 108, which may be superimposed or otherwise encoded with approvals or denials for submitted transactions and may, if applicable, include electronic certificates provided by the regulatory node 108. The receiving device 202 may also be configured to receive data signals electronically transmitted by nodes in the blockchain network, which may be superimposed or otherwise encoded with new blockchain data values or blocks for confirmation, confirmation messages, etc.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, generation module 216, validation module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include blockchain data 206. The blockchain data 206 may include the opaque, permissioned blockchain as well as any additional data for use in maintaining the blockchain, generating new blocks, confirming blocks and blockchain data values, etc. The blockchain may include a plurality of blocks, where each block includes a block header and one or more blockchain data values. The additional data may include, for instance, key generation algorithms, signature generation algorithms, public keys, electronic certificates, etc.

The processing server 102 may also include an entity table 208. The entity table 208 may be data storage used to store information regarding entities that are registered for use of the opaque, permissioned blockchain. The entity table 208 may be configured to store data using suitable data formatting methods and schema and may be any suitable type of memory, such as read-only memory, random access memory, etc. The entity table 208 may include an entry for each registered entity, where the entry may include an identifier, network address for the entity's associated computing system, electronic certificate provisioned to the entity's associated computing system, public key of the entity's cryptographic key pair, information regarding regulatory agencies to which the entity is subject, etc.

The processing server 102 may also include a memory 210. The memory 210 may be configured to store data for use by the processing server 102 in performing the functions discussed herein, such as public and private keys, symmetric keys, etc. The memory 210 may be configured to store data using suitable data formatting methods and schema and may be any suitable type of memory, such as read-only memory, random access memory, etc. The memory 210 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 210 may be comprised of or may otherwise include a relational database that utilizes structured query language for the storage, identification, modifying, updating, accessing, etc. of structured data sets stored therein.

The processing server 102 may include a querying module 214. The querying module 214 may be configured to execute queries on databases to identify information. The querying module 214 may receive one or more data values or query strings, and may execute a query string based thereon on an indicated database, such as the entity table 208 of the processing server 102 to identify information stored therein. The querying module 214 may then output the identified information to an appropriate engine or module of the processing server 102 as necessary. The querying module 214 may, for example, execute a query on the entity table 208 to identify a network address for the second computing system 106 using an identifier received from the first computing system 104 by the receiving device 202 for establishing the secure communication channel 110.

The processing server 102 may also include a generation module 216. The generation module 216 may be configured to generate data for use by the processing server 102 in performing the functions discussed herein. The generation module 216 may receive instructions as input, may generate data based on the instructions, and may output the generated data to one or more modules of the processing server 102. For example, the generation module 216 may be configured to generate blockchain data values, new blocks, cryptographic key pairs, electronic certificates, etc. The generation module 216 may also be configured to generate secure communication channels 110 and 112 and generate data for use in establishing of such channels.

The processing server 102 may also include a validation module 218. The validation module 218 may be configured to perform validations for the processing server 102 as part of the functions discussed herein. The validation module 218 may receive instructions as input, which may also include data to be used in performing a validation, may perform a validation as requested, and may output a result of the validation to another module or engine of the processing server 102. The validation module 218 may, for example, be configured to validate digital signatures, validate digital certificates, validate received blockchain data values and blocks, etc.

The processing server 102 may also include a transmitting device 220. The transmitting device 220 may be configured to transmit data over one or more networks via one or more network protocols. In some instances, the transmitting device 220 may be configured to transmit data to first computing systems 104, second computing systems 106, regulatory nodes 108, and other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to first computing systems 104 and second computing systems 106 that may be superimposed or otherwise encoded with electronic certificates or cryptographic keys as part of registration, communication data for use in establishing the secure communication channel 110, requests for regulatory information, requests for transaction data, transaction hashes, etc. The transmitting device 220 may also be configured to electronically transmit data signals to regulatory nodes 108 that are superimposed or otherwise encoded with communication data for establishing the secure communication channel 112, transaction data for approval, electronic certificates or cryptographic keys, information regarding entities subject to regulation, etc.

### Process for Regulatory Oversight of Blockchain-Based Transactions

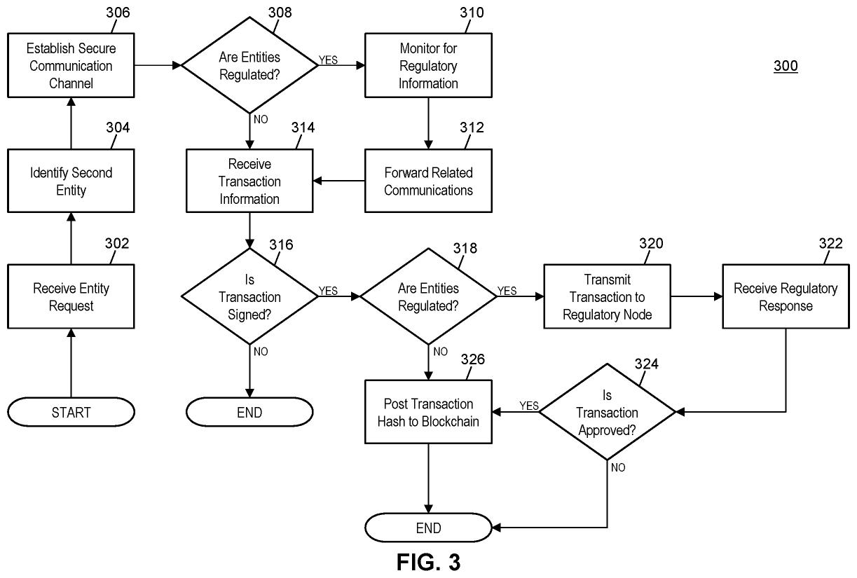

FIG. 3 illustrates a process 300 for ensuring regulatory oversight for transactions that are stored on an opaque, permissioned blockchain when applicable.

In step 302, the receiving device 202 of the processing server 102 may receive an entity request from the first computing system 104 submitted using a suitable communication network and method, such as via an application programming interface provided by the processing server 102. The entity request may include an identifier associated with the second computing system 106 or an entity associated therewith. In step 304, the querying module 214 of the processing server 102 may execute a query on the entity table 208 stored in the processing server 102 to identify connection information for the second computing system 106 using the received identifier. In step 306, the processing server 102 may establish the secure communication channel 110 between the first computing system 104 and the second computing system 106, which may enable the first computing system 104 and the second computing system 106 to securely transfer messages and data for agreement on a transaction. In an exemplary embodiment, the processing server 102 may be unable to view any of the data exchanges using the secure communication channel 110.

In step 308, the processing server 102 may determine if the entities associated with the first computing system 104 or second computing system 106 are regulated. The determination may be based on, for instance, data stored in entries in the entity table 208 for each of the two entities. If either of the entities is regulated (or if both are regulated), then, in step 310, the processing server 102 may monitor for regulatory information that must be provided to the regulatory agency. Such monitoring may be performed via review of exchanged data in the secure communication channel 110, requests for data submitted to the first computing system 104 and/or second computing system 106, as applicable, or other suitable method. In step 312, the transmitting device 220 of the processing server 102 may forward communications that include data subject to regulation to the regulatory node 108, such as using a secure communication channel 112 or other suitable communication network and method. If, in step 308, the processing server 102 determines that neither entity is regulated, process 300 may proceed directly to step 314.

In step 314, the receiving device 202 of the processing server 102 may receive transaction data for an agreed-upon transaction from the first computing system 104 or the second computing system 106. The transaction data may include a hash of the transaction data for inclusion in a new blockchain data value generated by the processing server 102 and included in a new block, or may include the transaction data for generation of the hash by the processing server 102. In step 316, the processing server 102 may determine if the transaction is signed by both the first computing system 104 and the second computing system 106. The determination may be based on the existence of digital signatures from both systems in the received transaction data, and successful validation of the digital signatures using public keys associated with each system, as identified in the appropriate entries in the entity table 208. If the signatures are not provided, or either digital signature is invalid, then the process 300 may be ended and the transaction not entered as a result. In some cases, a notification message may be transmitted to the first computing system 104 and/or second computing system 106 regarding the failed validation.

If the transaction is accompanied by two valid digital signatures, then, in step 318, the processing server 102 may determine if either entity involved in the transaction is regulated, such as using the same determination in step 308. If the entities are regulated, then, in step 320, the transmitting device 220 of the processing server 102 may electronically transmit the transaction data and information identifying the regulated entity to an applicable regulatory node 108. In cases where the transaction may be subject to regulation by multiple agencies, more than one regulatory node 108 may be provided with the transaction information. In some instances, the secure communication channel 112 may be used. In step 322, the receiving device 202 of the processing server 102 may receive a response from the regulatory node 108, where the response indicates approval or denial of the transaction. In the case of approval, the response may also include a digital signature generated by the regulatory node 108, which may be validated by the validation module 218 of the processing server 102 using a public key associated with the regulatory node 108.

In step 324, the processing server 102 may determine if the transaction is approved, which may also require successful validation of the regulatory node's digital signature. If the transaction is not approved, or the validation fails, then the process 300 may be completed and the transaction not entered. In some instances, a notification may be transmitted to the regulatory node 108 (e.g., to inform of a failed validation) or to the first computing system 104 and/or second computing system 106 (e.g., to inform of a failed regulation). If the transaction is approved or, in step 318, the processing server 102 determines the entities are not subject to regulation, then, in step 326, the transaction hash for the transaction may be included as a blockchain data value in a new block generated by the generation module 216 of the processing server 102, which may be transmitted to other nodes in the blockchain network for confirmation and then addition to the blockchain. In some embodiments, the processing server 102 may first digitally sign the transaction hash using its own private key, such as in cases where the processing server 102 is a moderating node for the permissioned blockchain. The transaction hash may then be on the blockchain, for later verification and auditing by the involved entities and regulatory agencies, where the regulatory agency automatically received the relevant data as part of the transaction process, negating the need for self-reporting by the involved entities.

### Exemplary Method for Ensuring Regulatory Oversight

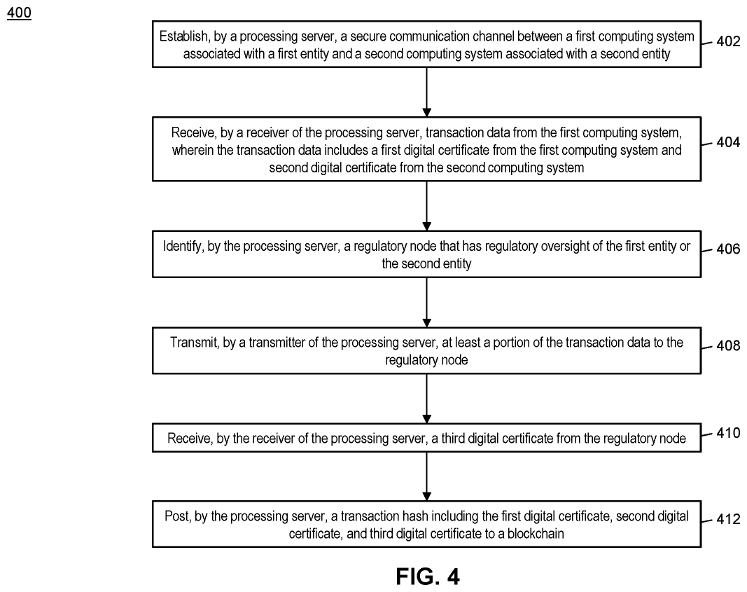

FIG. 4 illustrates a method 400 for ensuring regulatory oversight of transaction activity and storage thereof on a blockchain through the use of secure communication channels and digital certificates.

In step 402, a secure communication channel (e.g., the secure communication channel 110) may be established by a processing server (e.g., the processing server 102) between a first computing system (e.g., the first computing system 104) associated with a first entity and a second computing system (e.g., the second computing system 106) associated with a second entity. In step 404, transaction data may be received by a receiver (e.g., the receiving device 202) of the processing server from the first computing system, wherein the transaction data includes a first digital certificate from the first computing system and second digital certificate from the second computing system. In step 406, a regulatory node (e.g., the regulatory node 108) that has regulatory oversight of the first entity or the second entity may be identified by the processing server.

In step 408, at least a portion of the transaction data may be transmitted by a transmitter (e.g., the transmitting device 220) of the processing server to the regulatory node. In step 410, a third digital certificate may be received by the receiver of the processing server from the regulatory node. In step 412, a transaction hash including the first digital certificate, second digital certificate, and third digital certificate may be posted to a blockchain by the processing server.

In one embodiment, the transaction data may include the transaction hash. In some embodiments, the first digital certificate, second digital certificate, and third digital certificate may be digital signatures generated by signing the transaction hash using an electronic certificate or private key. In one embodiment, the processing server may not retain any data transmitted using the secure communication channel. In some embodiments, the method 400 may further include monitoring, by the processing server, one or more communication messages exchanged between the first computing system and the second computing system using the secure communication channel. In a further embodiment, the method 400 may even further include transmitting, by the transmitter of the processing server, the monitored one or more communication messages to the regulatory node, wherein the one or more communication messages are monitored in compliance with the regulatory oversight of the regulatory node. In one embodiment, the method 400 may also include generating, by the processing server, a fourth digital certificate, wherein the transaction hash further includes the fourth digital certificate. In a further embodiment, the fourth digital certificate may be generated by signing the transaction hash using an electronic certificate or private key.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for ensuring regulatory oversight of transaction activity and storage thereof on a blockchain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for ensuring regulatory oversight of transaction activity and storage thereof on a blockchain, comprising:
establishing, by a processing server, a secure communication channel between a first computing system associated with a first entity and a second computing system associated with a second entity;
receiving, by a receiver of the processing server, transaction data from the first computing system, wherein the transaction data includes a first digital certificate from the first computing system and second digital certificate from the second computing system;
identifying, by the processing server, a regulatory node that has regulatory oversight of the first entity or the second entity;
transmitting, by a transmitter of the processing server, at least a portion of the transaction data to the regulatory node;
receiving, by the receiver of the processing server, a third digital certificate from the regulatory node; and
posting, by the processing server, a transaction hash including the first digital certificate, second digital certificate, and third digital certificate to a blockchain.

2. The method of claim 1, wherein the transaction data includes the transaction hash.

3. The method of claim 1, wherein the first digital certificate, second digital certificate, and third digital certificate are digital signatures generated by signing the transaction hash using an electronic certificate or private key.

4. The method of claim 1, wherein the processing server does not retain any data transmitted using the secure communication channel.

5. The method of claim 1, further comprising:
monitoring, by the processing server, one or more communication messages exchanged between the first computing system and the second computing system using the secure communication channel.

6. The method of claim 5, further comprising:
transmitting, by the transmitter of the processing server, the monitored one or more communication messages to the regulatory node, wherein
the one or more communication messages are monitored in compliance with the regulatory oversight of the regulatory node.

7. The method of claim 1, further comprising:
generating, by the processing server, a fourth digital certificate, wherein
the transaction hash further includes the fourth digital certificate.

8. The method of claim 7, wherein the fourth digital certificate is generated by signing the transaction hash using an electronic certificate or private key.

9. A system for ensuring regulatory oversight of transaction activity and storage thereof on a blockchain, comprising:
a first computing system associated with a first entity;
a second computing system associated with a second entity;
a regulatory node; and
a processing server, wherein the processing server
establishes a secure communication channel between the first computing system and the second computing system,
receives, by a receiver of the processing server, transaction data from the first computing system, wherein the transaction data includes a first digital certificate from the first computing system and second digital certificate from the second computing system,
identifies the regulatory node having regulatory oversight of the first entity or the second entity,
transmits, by a transmitter of the processing server, at least a portion of the transaction data to the regulatory node,
receives, by the receiver of the processing server, a third digital certificate from the regulatory node, and
posts a transaction hash including the first digital certificate, second digital certificate, and third digital certificate to a blockchain.

10. The system of claim 1, wherein the transaction data includes the transaction hash.

11. The system of claim 1, wherein the first digital certificate, second digital certificate, and third digital certificate are digital signatures generated by signing the transaction hash using an electronic certificate or private key.

12. The system of claim 1, wherein the processing server does not retain any data transmitted using the secure communication channel.

13. The system of claim 1, wherein the processing server further modifies one or more communication messages exchanged between the first computing system and the second computing system using the secure communication channel.

14. The system of claim 13, wherein
the processing server further transmits, by the transmitter of the processing server, the monitored one or more communication messages to the regulatory node, and
the one or more communication messages are monitored in compliance with the regulatory oversight of the regulatory node.

15. The system of claim 9, wherein
the processing server further generates a fourth digital certificate, and
the transaction hash further includes the fourth digital certificate.

16. The system of claim 15, wherein the fourth digital certificate is generated by signing the transaction hash using an electronic certificate or private key.
